(19) United States
(12) Patent Application Publication
(10) Pub. No.: US 2025/0206485 A1
(43) Pub. Date: Jun. 26, 2025

(54) FEEDING DEVICE AND FEEDING SYSTEM INCLUDING THE SAME

(71) Applicant: SK ON CO., LTD., Seoul (KR)

(72) Inventors: Ji Yun YANG, Daejeon (KR); In Mok KIM, Daejeon (KR)

(21) Appl. No.: 18/959,610

(22) Filed: Nov. 26, 2024

(30) Foreign Application Priority Data
Dec. 20, 2023 (KR) 10-2023-0187239

(51) Int. Cl. B65B 69/00

(52) U.S. Cl. CPC B65B 69/0008; B65B 69/005

(57) ABSTRACT

A feeding device is disclosed. The feeding device according to the present disclosure may comprise a feeding housing open upward; a roller rotatably coupled to the feeding housing, at least a part of the roller being accommodated in the feeding housing; and a cutter unit positioned in the feeding housing and protruding upward. The roller may rotate while facing a face of the feeding housing.

### CROSS-REFERENCE TO RELATED APPLICATION AND CLAIM OF PRIORITY

This application claims priority to Korean Patent Application No. 10-2023-0187239 filed on Dec. 20, 2023 in the Korean Intellectual Property Office (KIPO), the entire disclosure of which is incorporated by reference herein.

### TECHNICAL FIELD

The present disclosure relates to a feeding device and a feeding system including the same. More particularly, the present disclosure relates to a feeding device cutting a bag containing a powder and feeding the powder and a feeding system including the feeding device.

### BACKGROUND

An active material used in a secondary battery may be processed in the form of powder and applied to an electrode. In a related art, in a process of feeding powder, a bag containing the powder was manually cut, the powder was put into a feeding device, and the bag from which the powder was discharged was manually discharged.

However, cost and safety problems may arise in the process of manually cutting the bag, manually putting the powder into the feeding device, and manually discharging the bag.

### SUMMARY

An object of the present disclosure is to provide a feeding device and a feeding method for cutting a bag containing a powder and discharging the bag.

To archive the above-described or other objects, in one aspect of the present disclosure, there is provided a feeding device comprising a feeding housing open upward; a roller rotatably coupled to the feeding housing, at least a part of the roller being accommodated in the feeding housing; and a cutter unit positioned inside the feeding housing and protruding upward, wherein the roller rotates while facing a face of the feeding housing.

In one aspect of the present disclosure, there is provided a feeding system comprising a feeding device and a transfer device positioned behind the feeding device, wherein the feeding device includes a feeding housing open upward; a roller rotatably coupled to the feeding housing, at least a part of the roller being accommodated in the feeding housing; and a cutter unit positioned inside the feeding housing and protruding upward, wherein the roller rotates while facing a face of the feeding housing, wherein the transfer device includes a conveyor frame positioned behind the feeding housing; and a first conveyor module and a second conveyor module which are coupled to the conveyor frame and arranged side by side.

In one aspect of the present disclosure, there is provided a feeding method of cutting a bag containing a powder and feeding the powder comprising measuring a state of the bag in a state where the bag is put into a feeding housing; determining whether the state of the bag is a final state; when the state of the bag is the final state, determining whether the bag has been discharged from the feeding housing; when the bag has not been discharged from the feeding housing, determining whether a period in which the final state is maintained is greater than or equal to a second period; and when the period in which the final state is maintained is greater than or equal to the second period, reshaping the bag in the feeding housing, wherein after reshaping the bag is completed, measuring the state of the bag is performed.

According to at least one aspect of the present disclosure, a feeding device cutting a bag containing a powder and discharging the bag and a feeding system including the feeding device can be provided.

A feeding device and a feeding system including the same according to some embodiments of the present disclosure can be widely applied in green technology fields such as electric vehicles, battery charging stations, and other battery-based solar power generation and wind power generation.

A feeding device and a feeding system including the same according to some embodiments of the present disclosure can be used in eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a feeding device according to an embodiment of the present disclosure.

FIG. 2 illustrates a cross section of a feeding device illustrated in FIG. 1 taken along A1-A2.

FIG. 3 illustrates a feeder unit according to an embodiment of the present disclosure.

FIG. 4 illustrates that a discharge auxiliary unit is coupled to a feeding housing, as a cross section of a feeding device illustrated in FIG. 1 taken along A1-A2.

FIG. 5 illustrates a transfer device according to an embodiment of the present disclosure.

FIG. 6 is a block diagram of a feeding device according to an embodiment of the present disclosure.

FIG. 7 is a block diagram of a transfer device according to an embodiment of the present disclosure.

FIG. 8 is a flowchart illustrating a feeding method according to an embodiment of the present disclosure.

FIG. 9 is a flowchart illustrating a bag reshaping step according to an embodiment of the present disclosure.

### DETAILED DESCRIPTION OF THE EMBODIMENTS

Reference will now be made in detail to embodiments of the present disclosure, examples of which are illustrated in the accompanying drawings. However, the following description is merely an example and does not intended to limit the present disclosure to a specific implementation.

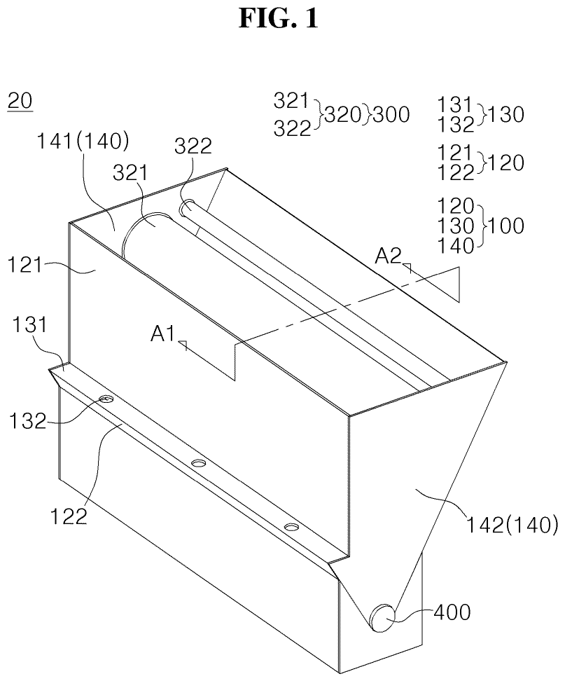

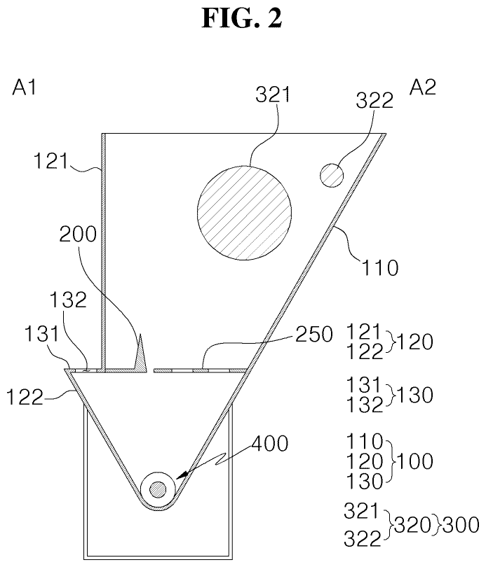

FIG. 1 illustrates a feeding device according to an embodiment of the present disclosure. FIG. 2 illustrates a cross section of a feeding device illustrated in FIG. 1 taken along A1-A2.

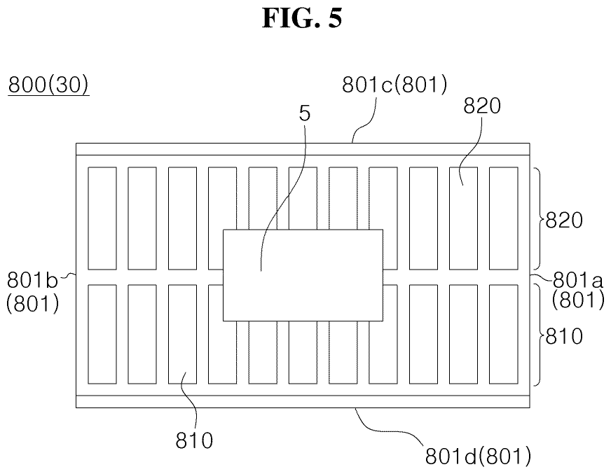

Referring to FIGS. 1 and 2, a bag 5 (see FIG. 5) may be put into a feeding device 20. The bag 5 (see FIG. 5) may contain a powder. The powder contained in the bag 5 (see FIG. 5) may include, for example, a material used in a secondary battery.

When the bag 5 (see FIG. 5) is put into the feeding device 20, the bag 5 (see FIG. 5) may be cut and the powder contained in the bag 5 (see FIG. 5) may be transferred by a feeder unit 400. The bag 5 (see FIG. 5) from which the powder is discharged may be discharged to the outside of a feeding housing 100 by a roller unit 300.

The feeding device 20 may include the feeding housing 100. The feeding housing 100 may form an upwardly open space. The bag 5 (see FIG. 5) may be put into the feeding housing 100 from above the feeding housing 100.

The feeding housing 100 may include, for example, a housing front portion 110. The housing front portion 110 may form a face of the feeding housing 100. For example, the housing front portion 110 may form a front face of the feeding housing 100.

The housing front portion 110 may form an inner face and an outer face. For example, the inner face of the housing front portion 110 may face or be directed toward a space formed in the feeding housing 100. For example, the outer face of the housing front portion 110 may face or be directed forward.

For example, the housing front portion 110 may face the front at an angle. For example, the housing front portion 110 may face the bottom at an angle. For example, the housing front portion 110 may face or be directed forward-downward. For example, the housing front portion 110 may face or be directed forward-upward.

The housing front portion 110 may form an incline with respect to a vertical plane. For example, the housing front portion 110 may be positioned further back as it goes downward. That is, an upper end of the housing front portion 110 may be positioned in front of a lower end of the housing front portion 110. For example, when the powder is put into the inner face of the housing front portion 110, the powder may move downward along the inner face of the housing front portion 110.

The feeding housing 100 may include a housing rear portion 120. The housing rear portion 120 may form another face of the feeding housing 100. For example, the housing rear portion 120 may form a rear face of the feeding housing 100.

The housing rear portion 120 may form an inner face and an outer face. For example, the inner face of the housing rear portion 120 may face or be directed toward a space formed in the feeding housing 100. For example, the outer face of the housing rear portion 120 may face or be directed rearward.

The inner face of the housing rear portion 120 may face the inner face of the housing front portion 110. The housing rear portion 120 may be inclined to the housing front portion 110. For example, the housing rear portion 120 and the housing front portion 110 may form an angle. For example, a horizontal distance between the housing rear portion 120 and the housing front portion 110 may decrease as it goes downward.

The feeding housing 100 may include a housing vent 130. The housing vent 130 may be coupled to the housing rear portion 120. The housing vent 130 may include a vent body 131 and a vent opening 132. The vent body 131 may be coupled to the housing rear portion 120.

The housing rear portion 120 may include an upper rear portion 121 and a lower rear portion 122. For example, the vent body 131 may extend rearward from a lower end of the upper rear portion 121 and may be connected to an upper end of the lower rear portion 122.

The vent body 131 may form a plate shape. The vent body 131 may form an outer face and an inner face. The outer face of the vent body 131 may be an upper surface of the vent body 131. The inner face of the vent body 131 may be a lower face of the vent body 131.

The outer face of the vent body 131 may face or be directed upward. The inner face of the vent body 131 may face or be directed toward a space formed in the feeding housing 100. The inner face of the vent body 131 may face or be directed downward.

The vent opening 132 may be an opening formed in the vent body 131. The vent opening 132 may extend from the inner face of the vent body 131 and lead to the outer face of the vent body 131.

The feeding housing 100 may include a housing lateral portion 140. The housing lateral portion 140 may extend rearward from the housing front portion 110 and lead to the housing rear portion 120.

The housing lateral portion 140 may include a first housing lateral portion 141. The first housing lateral portion 141 may extend rearward from a first end of the housing front portion 110 and lead to a first end of the housing rear portion 120.

The housing lateral portion 140 may include a second housing lateral portion 142. The second housing lateral portion 142 may extend rearward from a second end of the housing front portion 110 and lead to a second end of the housing rear portion 120.

The first housing lateral portion 141 may form a lateral face of the feeding housing 100. For example, the first housing lateral portion 141 may form a right lateral face of the feeding housing 100.

The second housing lateral portion 142 may form another lateral face of the feeding housing 100. For example, the second housing lateral portion 142 may form a left lateral face of the feeding housing 100. The second housing lateral portion 142 and the first housing lateral portion 141 may face each other.

The feeding device 20 may include a cutter unit 200. The cutter unit 200 may be positioned inside the feeding housing 100. For example, the cutter unit 200 may be coupled to the feeding housing 100. The cutter unit 200 may protrude upward. For example, the cutter unit 200 may be pointed upward.

The feeding device 20 may include a filter 250. The filter 250 may be coupled to the feeding housing 100. The filter 250 may be adjacent to the cutter unit 200. The filter 250 may form a shape of a net that forms at least one opening. For example, the filter 250 may pass the powder contained in the bag 5 (see FIG. 5) and may not pass the bag 5 (see FIG. 5).

The feeding device 20 may include the feeder unit 400. The feeder unit 400 may be positioned or coupled to the feeding housing 100. The feeder unit 400 may be positioned below the cutter unit 200. The feeder unit 400 may be positioned below the filter 250. The feeder unit 400 may transfer the powder contained in the bag 5 (see FIG. 5) to the outside of the feeding housing 100.

The feeding device 20 may include the roller unit 300. The roller unit 300 may include a roller 320. The roller 320 may be coupled to the feeding housing 100. At least a part of the roller 320 may be positioned inside the feeding housing 100.

A plurality of rollers 320 may be provided. For example, the roller unit 300 may include a main roller 321 and a sub-roller 322. The main roller 321 may be referred to as a “first roller”. The sub-roller 322 may be referred to as a “second roller”. The roller 320 may include or indicate, for example, at least one of the main roller 321 and the sub-roller 322.

For example, an outer face of the roller 320 may be surface-treated. For example, the outer face of the roller 320 may be roughened. For example, a member including silicone may be attached to the outer face of the roller 320.

For example, a coefficient of friction of the outer face of the roller 320 may be processed to be relatively high, or unevenness may be formed on the surface of the roller 320. As a result, the bag 5 (see FIG. 5) can easily move upward by the roller 320.

The roller 320 may be coupled to the housing lateral portion 140. For example, the roller 320 may be rotatably coupled to the housing lateral portion 140. For example, the roller 320 may rotate about an axis of the roller 320. The axis of the roller 320 may be referred to as “central axis of the roller 320”.

The roller 320 may rotate while facing the face of the feeding housing 100. For example, the roller 320 may rotate while facing the housing front portion 110. For example, the roller 320 may rotate while facing the inner face of the housing front portion 110.

The roller 320 may be positioned behind the housing front portion 110. The roller 320 may be spaced apart from the housing front portion 110. The roller 320 may be disposed between the housing front portion 110 and the housing rear portion 120.

For example, the roller 320 may be disposed between the housing front portion 110 and the upper rear portion 121. A distance between the roller 320 and the housing front portion 110 may be less than a distance between the rollers 320 and the housing rear portion 120.

A central axis of the sub-roller 322 may be higher than a central axis of the main roller 321. A distance between the sub-roller 322 and the housing front portion 110 may be less than a distance between the main roller 321 and the housing front portions 110.

A radius of the main roller 321 may be different from a radius of the sub-roller 322. For example, the radius of the main roller 321 may be greater than the radius of the sub-roller 322. A radius of the roller 320 may refer to a distance from a central axis of the roller 320 to the outer face of the roller 320 in a radial direction.

For example, when the roller 320 rotates in a first rotational direction, an upper face of the roller 320 may face the housing rear portion 120. For example, when the roller 320 rotates in the first rotational direction, a rear face of the roller 320 may face downward. For example, when the roller 320 rotates in the first rotational direction, a lower face of the roller 320 may face the housing front portion 110.

A second rotational direction may be a direction opposite to the first rotational direction. When the roller 320 rotates in the first rotational direction, the bag 5 (see FIG. 5) positioned between the roller 320 and the housing front portion 110 may be discharged to the outside of the feeding housing 100 by the roller 320. In this context, the first rotational direction may be referred to as a “discharge rotational direction”.

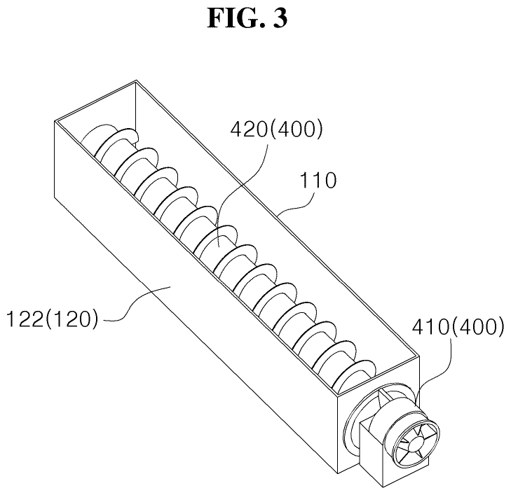

FIG. 3 illustrates the feeder unit according to an embodiment of the present disclosure.

Referring to FIG. 3, the feeder unit 400 may include a feeder driver 410. The feeder driver 410 may include, for example, a motor. The feeder driver 410 may generate, for example, a rotational force.

The feeder unit 400 may include a feeder screw 420. The feeder screw 420 may be connected or coupled to the feeder driver 410. The feeder screw 420 may be provided with the rotational force from the feeder driving unit 410. The feeder screw 420 may rotate.

The feeder screw 420 may be positioned between the housing front portion 110 and the housing rear portion 120. For example, the feeder screw 420 may be positioned between the housing front portion 110 and the lower rear portion 122.

When the powder is provided to the feeder screw 420, the feeder screw 420 may transfer the powder. For example, the feeder screw 420 may transfer the powder in an axial direction of the feeder screw 420.

Referring to FIGS. 1 to 3, the bag 5 (see FIG. 5) put into the feeding housing 100 may be in an initial state. The initial state of the bag 5 (see FIG. 5) may be a state in which the powder is contained in the bag 5 (see FIG. 5) and the bag 5 (see FIG. 5) is not cut.

The bag 5 (see FIG. 5) in the initial state may be inserted between the housing rear portion 120 and the roller 320. The roller 320 may rotate in the first rotational direction. For example, the main roller 321 may move the bag 5 (see FIG. 5) downward while rotating in the first rotational direction.

The bag 5 (see FIG. 5) may be cut by the cutter unit 200. For example, a lower face of the bag 5 (see FIG. 5) may be cut by the cutter unit 200. When the bag 5 (see FIG. 5) is cut, the powder contained in the bag 5 (see FIG. 5) may be discharged from the bag 5 (see FIG. 5). The powder discharged from the bag 5 (see FIG. 5) may pass through the filter 250 and reach the feeder unit 400.

The bag 5 (see FIG. 5) discharged to the outside of the feeding housing 100 by the roller 320 may be in a final state. The final state of the bag 5 (see FIG. 5) may be a state in which the bag 5 (see FIG. 5) is cut and all the powder is discharged from the bag 5 (see FIG. 5).

The bag 5 (see FIG. 5) in the final state may move toward the housing front portion 110 by, for example, the main roller 321. When the bag 5 (see FIG. 5) is interposed between the roller 320 and the housing front portion 110, the roller 320 may move the bag 5 (see FIG. 5) upward. That is, the bag 5 (see FIG. 5) may be positioned between the roller 320 and the housing front portion 110 and may move upward.

The bag 5 (see FIG. 5) may be in an intermediate state. The intermediate state of the bag 5 (see FIG. 5) may be a state between the initial state and the final state. In other words, in the intermediate state, the bag 5 (see FIG. 5) may be in a cut state, and a part of the powder contained in the bag 5 (see FIG. 5) in the initial state may be discharged and another part may remain in the bag 5 (see FIG. 5).

If the bag 5 (see FIG. 5) is not interposed between the roller 320 and the housing front portion 110, it may be difficult for the bag 5 (see FIG. 5) to be discharged to the outside of the feeding housing 100. Therefore, a means for inserting the bag 5 (see FIG. 5) between the roller 320 and the housing front portion 110 may be required.

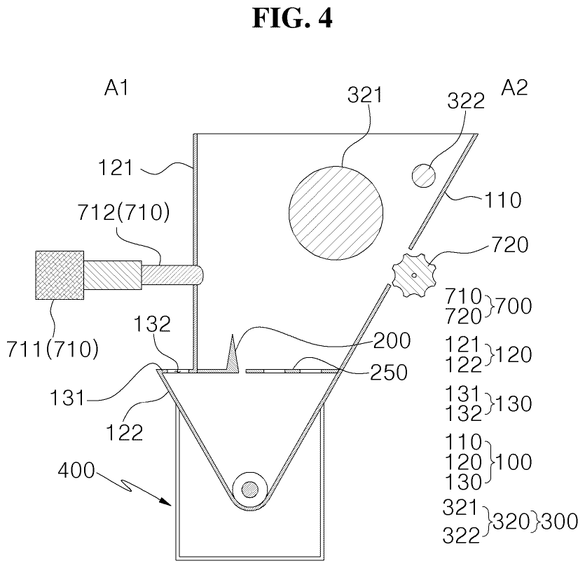

FIG. 4 illustrates that a discharge auxiliary unit is coupled to the feeding housing, as a cross section of the feeding device illustrated in FIG. 1 taken along A1-A2.

Referring to FIGS. 1 and 4, the feeding device 20 may include a discharge auxiliary unit 700. The discharge auxiliary unit 700 may include a push module 710. The push module 710 may be coupled to the feeding housing 100. For example, the push module 710 may be coupled to the housing rear portion 120. For example, the push module 710 may be coupled to the upper rear portion 121.

The push module 710 may include a push driver 711 and a push rod 712. The push rod 712 may be connected or coupled to the push driver 711. The push rod 712 may be provided with a driving force from the push driver 711.

The upper rear portion 121 may include an opening. The push rod 712 may be positioned in the opening of the upper rear portion 121. The push rod 712 may move forward from the upper rear portion 121. The opening formed in the upper rear portion 121 may be referred to as a “rear opening”.

For example, the push rod 712 may be extended forward from the upper rear portion 121. For example, the push rod 712 may protrude or extend forward from the upper rear portion 121. For example, the push rod 712 may push the bag 5 (see FIG. 5) forward from behind the bag 5 (see FIG. 5).

The discharge auxiliary unit 700 may include a pulling module 720. The pulling module 720 may be coupled to the feeding housing 100. For example, the pulling module 720 may be coupled to the housing front portion 110.

The pulling module 720 may rotate in the second rotational direction. At least a part of the pulling module 720 may be positioned inside the feeding housing 100. For example, the pulling module 720 may be positioned in an opening formed in the housing front portion 110. The opening formed in the housing front portion 110 may be referred to as a “front opening”.

The bag 5 (see FIG. 5) may be positioned between the pulling module 720 and the push rod 712. When the pulling module 720 rotates in the second rotational direction, the pulling module 720 may move the bag 5 (see FIG. 5) upward. When the bag 5 (see FIG. 5) moves upward, the bag 5 (see FIG. 5) may be interposed between the housing front portion 110 and the roller 320. When the bag 5 (see FIG. 5) is interposed between the housing front portion 110 and the roller 320, the bag 5 (see FIG. 5) may move upward by the roller 320 and may be discharged to the outside of the feeding housing 100.

FIG. 5 illustrates a transfer device according to an embodiment of the present disclosure.

Referring to FIG. 5, a transport device 30 may include a conveyor unit 800. The conveyor unit 800 may include a conveyor frame 801. The conveyor frame 801 may form a perimeter.

For example, the conveyor frame 801 may include a conveyor front end portion 801a. The conveyor front end portion 801a may form a front end or a front face of the conveyor frame 801.

For example, the conveyor frame 801 may include a conveyor rear end portion 801b. The conveyor rear end portion 801b may form a rear end or a rear face of the conveyor frame 801.

For example, the conveyor frame 801 may include a first conveyor side end portion 801c. The first conveyor side end portion 801c may form a first side surface of the conveyor frame 801. The first conveyor side end portion 801c may extend rearward from an end of the conveyor front end portion 801a and lead to an end of the conveyor rear end portion 801b.

For example, the conveyor frame 801 may include a second conveyor side end portion 801d. The second conveyor side end portion 801d may form a second side surface of the conveyor frame 801. The second conveyor side end portion 801d may extend rearward from another end of the conveyor front end portion 801a and lead to another end of the conveyor rear end portion 801b.

The first side surface of the conveyor frame 801 may be a right surface of the conveyor frame 801. The second side surface of the conveyor frame 801 may be a left surface of the conveyor frame 801.

The conveyor frame 801 may form a shape extending in one direction. For example, the conveyor frame 801 may extend rearward from the conveyor front end portion 801a and lead to the conveyor rear end portion 801b.

The conveyor unit 800 may include a first conveyor module 810 and a second conveyor module 820. The first conveyor module 810 and the second conveyor module 820 may be disposed or coupled to the conveyor frame 801. The first conveyor module 810 and the second conveyor module 820 may be arranged side by side.

For example, the first conveyor module 810 may be adjacent to the first conveyor side end portion 801c. For example, the second conveyor module 820 may be adjacent to the second conveyor side end portion 801d.

The first conveyor module 810 and the second conveyor module 820 may transfer the bag 5. For example, the first conveyor module 810 and the second conveyor module 820 may transfer the bag 5 forward. That is, the first conveyor module 810 and the second conveyor module 820 may transfer the bag 5 from the conveyor rear end portion 801b to the conveyor front end portion 801a.

The first conveyor module 810 and the second conveyor module 820 may operate independently. For example, the first conveyor module 810 and the second conveyor module 820 may operate independently in terms of transport speed and/or direction. As the first conveyor module 810 and the second conveyor module 820 operate independently, the conveyor unit 800 may control an attitude of the bag 5.

The conveyor unit 800 may be connected or adjacent to the feeding device 20 (see FIG. 1). For example, the conveyor unit 800 may be positioned behind the feeding device 20 (see FIG. 1).

The conveyor unit 800 may provide the bag 5 to the feeding device 20 (see FIG. 1). For example, the conveyor unit 800 may put the bag 5 into the feeding housing 100 (see FIGS. 2 and 4). For example, the conveyor unit 800 may interpose the bag 5 between the housing rear portion 120 (see FIGS. 2 and 4) and the roller 320 (see FIGS. 2 and 4).

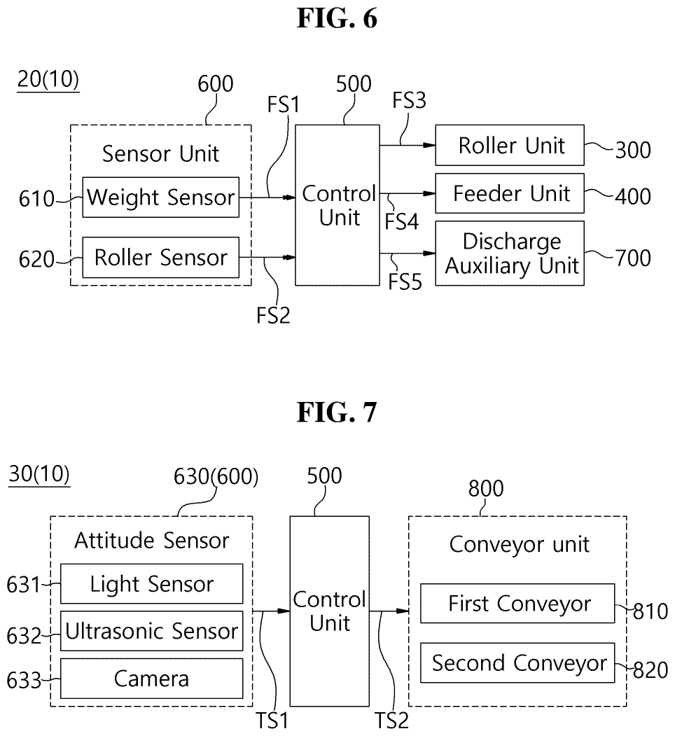

FIG. 6 is a block diagram of a feeding device according to an embodiment of the present disclosure.

Referring to FIGS. 1 to 6, a feeding system 10 according to an embodiment of the present disclosure may include the feeding device 20. The feeding device 20 may include a control unit 500.

The control unit 500 may process a signal. The control unit 500 may perform an operation. The control unit 500 may be implemented through at least one of a processor, a central processing unit (CPU), a graphical processing unit (GPU), a circuit board (CB), a printed circuit board (PCB), a flexible printed circuit board (FPCB), a computer, a laptop, or a server.

The control unit 500 may receive input feeding signals FS1 and FS2. The input feeding signals FS1 and FS2 may include at least one of a first feeding signal FS1 and a second feeding signal FS2.

The control unit 500 may generate output feeding signals FS3, FS4 and FS5 based on the input feeding signals FS1 and FS2. The output feeding signals FS3, FS4 and FS5 may include or indicate at least one of a third feeding signal FS3, a fourth feeding signal FS4, or a fifth feeding signal FS5.

The feeding device 20 may include a sensor unit 600. The sensor unit 600 may be connected to the control unit 500. For example, the sensor unit 600 may transmit at least one of the first feeding signal FS1 and the second feeding signal FS2 to the control unit 500.

The sensor unit 600 may include a weight sensor 610. The weight sensor 610 may be connected or coupled to the feeding housing 100. The weight sensor 610 may measure a weight applied to the feeding housing 100. For example, the weight sensor 610 may include a load cell.

For example, the weight sensor 610 may measure a weight of the bag 5 put into the feeding housing 100. When the powder contained in the bag 5 passes through the filter 250, a numerical value measured by the weight sensor 610 may decrease. The first feeding signal FS1 may include information on the weight of the bag 5 put into the feeding housing 100.

The control unit 500 may grasp a state of the bag 5 based on the first feeding signal FS1. For example, the control unit 500 may determine whether the bag 5 is in the final state based on the first feeding signal FS1.

If the bag 5 is in the initial state or the intermediate state, the control unit 500 may stand by without performing any additional operation. If the bag 5 is in the initial state or the intermediate state for a predetermined time or longer, the control unit 500 may determine that the powder is not being smoothly discharged from the bag 5.

If it is determined that the powder is not being smoothly discharged from the bag 5, the control unit 500 may operate the discharge auxiliary unit 700. For example, the control unit 500 may transmit the fifth feeding signal FS5 to the discharge auxiliary unit 700. The fifth feeding signal FS5 may include information on the operation of the discharge auxiliary unit 700.

For example, the push rod 712 may push the bag 5 forward in response to the fifth feeding signal FS5. For example, the pulling module 720 may rotate in the first rotational direction or the second rotational direction in response to the fifth feeding signal FS5. Hence, the bag 5 may move or shake. In this process, the powder contained in the bag 5 may be discharged from the bag 5.

The sensor unit 600 may include a roller sensor 620. The roller sensor 620 may measure a load applied to the roller 320. The bag 5 may be interposed between the roller 320 and the housing front portion 110.

When the bag 5 in the final state is positioned between the roller 320 and the housing front portion 110, the load applied to the roller 320 by the bag 5 may be relatively small. For example, when the bag 5 in the final state is positioned between the roller 320 and the housing front portion 110, the load measured by the roller sensor 620 may be greater than or equal to a first load and less than or equal to a second load. The second load may be greater than the first load.

When the bag 5 in the initial state or the intermediate state is positioned between the roller 320 and the housing front portion 110, the load applied to the roller 320 by the bag 5 may be relatively large. When the bag 5 in the initial state or the intermediate state is positioned between the roller 320 and the housing front portion 110, the roller sensor 620 may measure a load exceeding the second load.

The roller sensor 620 may transmit the second feeding signal FS2 to the control unit 500. The second feeding signal FS2 may include information on the load applied to the roller 320.

For another example, the roller sensor 620 may measure a rotational direction and a speed of the roller 320. For example, the roller sensor 620 may include an encoder connected or coupled to the roller 320.

The control unit 500 may grasp the state of the bag 5 based on the input feeding signals FS1 and FS2.

For example, the control unit 500 may determine whether the bag 5 is in the final state by determining the weight of the powder contained in the bag 5 based on the first feeding signal FS1.

For example, the control unit 500 may determine whether the bag 5 is in the final state by determining whether the bag 5 contains the powder based on the second feeding signal FS2.

For example, when the load measured by the roller sensor 620 is less than the first load, the control unit 500 may determine that the bag 5 is not interposed between the roller 320 and the housing front portion 110.

For example, when the load measured by the roller sensor 620 is greater than or equal to the first load and less than or equal to the second load, the control unit 500 may determine that the bag 5 in the final state is inserted between the roller 320 and the housing front portion 110. In this case, the control unit 500 may control the roller unit 300 so that the roller 320 can rotate in the first rotational direction. When the roller 320 rotates in the first rotational direction, the bag 5 may be discharged to the outside of the feeding housing 100.

For example, when the load measured by the roller sensor 620 exceeds the second load, the control unit 500 may determine that the bag 5 in the initial state or the intermediate state is inserted between the roller 320 and the housing front portion 110. In this case, the control unit 500 may control the roller unit 300 and the discharge auxiliary unit 700 to reshape the bag 5.

In the process of reshaping the bag 5, the control unit 500 may control the roller unit 300, and the roller 320 may rotate in the second rotational direction. When the roller 320 rotates in the second rotational direction, the bag 5 may move under the roller 320. Thereafter, the control unit 500 may control the discharge auxiliary unit 700 to shake the bag 5.

In the process of shaking the bag 5, the powder contained in the bag 5 may be discharged from the bag 5. The control unit 500 may control the roller unit 300, and the roller 320 may rotate in the first rotational direction.

The rotation of the roller 320 in the first rotational direction may mean that the roller 320 rotates forward. The rotation of the roller 320 in the second rotational direction may mean that the roller 320 rotates reverse.

The control unit 500 may control the roller unit 300. For example, the control unit 500 may transmit the third feeding signal FS3 to the roller unit 300. The roller unit 300 may operate in response to the third feeding signal FS3.

The control unit 500 may control the feeder unit 400. For example, the control unit 500 may transmit the fourth feeding signal FS4 to the feeder unit 400. The feeder unit 400 may operate in response to the fourth feeding signal FS4.

The control unit 500 may control the discharge auxiliary unit 700. For example, the control unit 500 may transmit the fifth feeding signal FS5 to the discharge auxiliary unit 700. The discharge auxiliary unit 700 may operate in response to the fifth feeding signal FS5.

FIG. 7 is a block diagram of a transfer device according to an embodiment of the present disclosure.

Referring to FIGS. 4 and 7, the feeding system 10 according to an embodiment of the present disclosure may include the transport device 30. The transport device 30 may include a control unit 500. The control unit 500 of the transfer device 30 may be substantially the same as the control unit 500 (see FIG. 6) of the feeding device 20 (see FIG. 5).

The control unit 500 may receive an input transfer signal TS1. The input transfer signal TS1 may include a first transfer signal TS1. An attitude sensor 630 may transmit the first transfer signal TS1 to the control unit 500.

The transfer device 30 may include a sensor unit 600. The sensor unit 600 may include the attitude sensor 630. The attitude sensor 630 may measure an attitude or/and a location of the bag 5 loaded on the conveyor unit 800.

The attitude sensor 630 may include a light sensor 631. The light sensor 631 may include, for example, a light transmitter that transmits at least one of a laser beam and infrared light, and a light receiver that receives light generated by the light transmitter.

The attitude sensor 630 may include an ultrasonic sensor 632. The ultrasonic sensor 632 may include an ultrasonic transmitter transmitting ultrasonic waves, and an ultrasonic receiver that receives ultrasonic waves generated by the ultrasonic transmitter.

The attitude sensor 630 may include a camera 633. The camera 633 may be disposed on the conveyor modules 810 and 820. The camera 633 may obtain an image of the bag 5. The conveyor modules 810 and 820 may include or indicate at least one of the first conveyor module 810 and the second conveyor module 820.

The control unit 500 may generate a second transfer signal TS2 based on the first transfer signal TS1. The second transfer signal TS2 may be transmitted to the conveyor unit 800.

The conveyor unit 800 may operate based on the second transfer signal TS2. The second transfer signal TS2 may include information on the operation of each of the first conveyor module 810 and the second conveyor module 820.

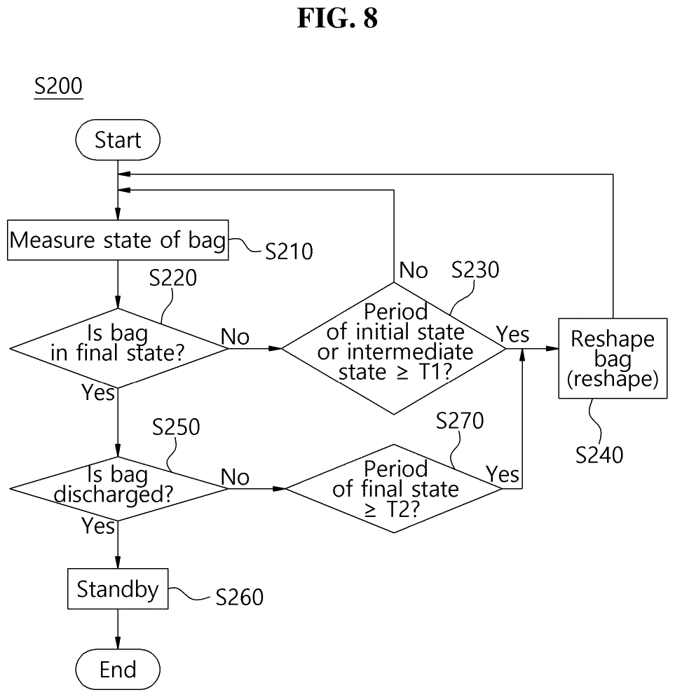

FIG. 8 is a flowchart illustrating a feeding method S200 according to an embodiment of the present disclosure.

Referring to FIGS. 1 to 4, 6 and 8, the feeding method S200 may include a step S210 of measuring a state of a bag. In the step S210, the sensor unit 600 may transmit at least one of the first feeding signal FS1 and the second feeding signal FS2 to the control unit 500.

The feeding method S200 may include a step S220 of determining whether the bag is in a final state. In the step S220, the control unit 500 may determine whether the bag 5 (see FIG. 5) is in the final state based on the input feeding signals FS1 and FS2.

The feeding method S200 may include a step S230 of comparing a period, in which the bag maintains the initial state or the intermediate state, with a first period T1. When it is determined that the bag 5 (see FIG. 5) is not in the final state, the control unit 500 may perform the step S230. When a period in which the bag maintains the initial state or the intermediate state is less than the first period T1, the step S210 of measuring the state of the bag may be performed.

The feeding method S200 may include a step S240 of reshaping the bag. When it is determined that the period in which the bag maintains the initial state or the intermediate state is greater than or equal to the first period T1, the control unit 500 may perform the step S240.

In the step S240, the control unit 500 may control the roller unit 300 and the discharge auxiliary unit 700. For example, in the step S240, at least one of the roller unit 300 and the discharge auxiliary unit 700 may move or shake the bag 5 (see FIG. 5). In this process, the powder contained in the bag 5 (see FIG. 5) may be discharged from the bag 5 (see FIG. 5). After the step S240 ends, the step S210 of measuring the state of the bag 5 (see FIG. 5) may be performed.

The feeding method S200 may include a step S250 of determining whether to discharge the bag. When it is determined that the bag 5 (see FIG. 5) is in the final state, the control unit 500 may determine whether the bag 5 (see FIG. 5) is discharged from the feeding housing 100.

It is assumed that a weight of the feeding housing 100 after the bag 5 (see FIG. 5) is discharged from the feeding housing 100 is substantially the same as a weight of the feeding house 100 before the bag 5 (see FIG. 5) is put into the feeding housing 100.

The control unit 500 may determine whether the bag 5 (see FIG. 5) is discharged from the feeding housing 100 based on this assumption and the first feeding signal FS1.

The bag 5 (see FIG. 5) passes between the roller 320 and the housing front portion 110 so that the bag 5 (see FIG. 5) is discharged from the feeding housing 100. When the bag 5 (see FIG. 5) passes between the roller 320 and the housing front portion 110, the load measured by the roller sensor 620 may be measured over time.

The load measured by the roller sensor 620 before the bag 5 (see FIG. 5) is inserted between the roller 320 and the housing front portion 110 is substantially zero.

When the bag 5 (see FIG. 5) is inserted and moves between the roller 320 and the housing front portion 110, the load measured by the roller sensor 620 is greater than or equal to the first load and less than or equal to the second load. The second load may be greater than the first load.

When the bag 5 (see FIG. 5) comes out between the roller 320 and the housing front portion 110, the load measured by the roller sensor 620 is substantially zero.

The control unit 500 may determine whether the bag 5 (see FIG. 5) is discharged from the feeding housing 100 based on this assumption and the second feeding signal FS2.

The feeding method S200 may include a standby step S260. The step S260 may be performed when it is determined that the bag 5 (see FIG. 5) has been discharged from the feeding housing 100. In the step S260, the feeding device 20 may wait for the introduction of a new bag 5 (see FIG. 5).

The feeding method S200 may include a step S270 of comparing a period in which the bag 5 (see FIG. 5) maintains the final state with a second period T2. When it is determined that the bag 5 (see FIG. 5) is not discharged from the feeding housing 100, the control unit 500 may perform the step S270.

When the period in which the bag 5 (see FIG. 5) maintains the final state is greater than or equal to the second period T2, the control unit 500 may perform the step S240 of reshaping the bag 5 (see FIG. 5). When the period in which the bag 5 (see FIG. 5) maintains the final state is less than the second period T2, the control unit 500 may perform the step S250 of determining whether the bag 5 (see FIG. 5) has been discharged.

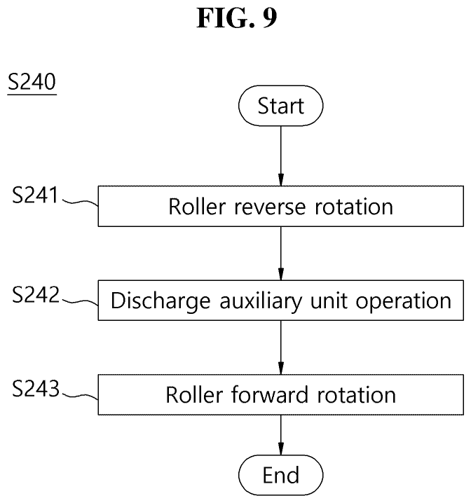

FIG. 9 is a flowchart illustrating a bag reshaping step according to an embodiment of the present disclosure.

Referring to FIGS. 1 to 4, 6, 8 and 9, the bag reshaping step S240 may include a roller reverse rotation step S241. In the step S241, the control unit 500 may transmit the third feeding signal FS3 to the roller unit 300, and the roller 320 may rotate reverse in response to the third feeding signal FS3.

In the step S241, the roller 320 may rotate in the second rotational direction. In the step S241, the control unit 500 may transmit the fifth feeding signal FS5 to the pulling module 720, and the pulling module 720 may rotate in the first rotational direction in response to the fifth feeding signal FS5.

Even if the bag 5 (see FIG. 5) is interposed between the roller 320 and the housing front portion 110, the bag 5 (see FIG. 5) may be disengaged from the roller 320 in the step S241.

The bag reshaping step S240 may include a discharge auxiliary unit operation step S242. In the step S242, the control unit 500 may transmit the fifth feeding signal FS5 to the discharge auxiliary unit 700, and in response to the fifth feeding signal FS5, the push rod 712 may move or extend in a forward-rearward direction, and the pulling module 720 may rotate. Hence, at least one of the attitude and the position of the bag 5 (see FIG. 5) with respect to the feeding housing 100 (see FIG. 4) may be changed.

In the step S242, the discharge auxiliary unit 700 may shake the bag 5 (see FIG. 5) or change the position of the bag 5 (see FIG. 5). In this process, the powder contained in the bag 5 (see FIG. 5) may be discharged from the bag 5 (see FIG. 5).

The bag reshaping step S240 may include a roller forward rotation step S243. In the step S243, the control unit 500 may transmit the third feeding signal FS3 to the roller unit 300, and the roller 320 may rotate forward in response to the fifth feeding signal FS5. In the step S243, the roller 320 may rotate in the first rotational direction.

In the step S243, the control unit 500 may transmit the fifth feeding signal FS5 to the pulling module 720, and the pulling module 720 may rotate in the second rotational direction in response to the fifth feeding signal FS5.

Only specific examples of implementations of certain embodiments are described. Variations, improvements and enhancements of the disclosed embodiments and other embodiments may be made based on the disclosure of this patent document.

What is claimed is:

1. A feeding device comprising:
a feeding housing open upward;
a roller rotatably coupled to the feeding housing, at least a part of the roller being accommodated in the feeding housing; and
a cutter unit positioned inside the feeding housing and protruding upward,
wherein the roller rotates while facing a face of the feeding housing.

2. The feeding device of claim 1, wherein the cutter unit is positioned below the roller.

3. The feeding device of claim 1, wherein the feeding housing includes:
a housing front portion positioned in front of the roller; and
a housing rear portion positioned behind the roller,
wherein a distance between the roller and the housing front portion is less than a distance between the roller and the housing rear portion.

4. The feeding device of claim 3, wherein the roller faces the housing front portion.

5. The feeding device of claim 4, wherein the housing front portion is inclined forward and upward.

6. The feeding device of claim 3, wherein the housing rear portion includes:
an upper rear portion extending downward from an upper end of the housing rear portion; and
a lower rear portion extending upward from a lower end of the housing rear portion,
wherein the feeding housing further includes a housing vent including a vent body, and
wherein the vent body extends rearward from a lower end of the upper rear portion and leads to an upper end of the lower rear portion.

7. The feeding device of claim 6, wherein the housing vent includes a vent opening as an opening formed in the vent body.

8. The feeding device of claim 1, wherein the roller includes:
a main roller coupled to the feeding housing; and
a sub-roller spaced apart from the main roller.

9. The feeding device of claim 8, wherein a rotational axis of the sub-roller is positioned above a rotational axis of the main roller.

10. The feeding device of claim 8, wherein the feeding housing includes:
a housing front portion positioned in front of the roller and inclined forward and upward; and
a housing rear portion positioned behind the roller,
wherein a distance between the main roller and the housing front portion is greater than a distance between the sub-roller and the housing front portion.

11. The feeding device of claim 1, further comprising a feeder unit positioned at a lower end of the feeding housing;
wherein the feeder unit includes:
a feeder driver; and
a feeder screw rotatably coupled to the feeder driver.

12. The feeding device of claim 1, further comprising a discharge auxiliary unit,
wherein the feeding housing includes:
a housing front portion positioned in front of the roller; and
a housing rear portion positioned behind the roller,
wherein the discharge auxiliary unit includes a push module including a push rod, and
wherein the push rod is positioned in an opening formed in the housing rear portion and is able to protrude from the housing rear portion toward the housing front portion.

13. The feeding device of claim 1, further comprising a discharge auxiliary unit,
wherein the feeding housing includes:
a housing front portion positioned in front of the roller; and
a housing rear portion positioned behind the roller,
wherein the discharge auxiliary unit includes a pulling module, and
wherein the pulling module is positioned in an opening formed in the housing front portion, at least a part of the pulling module is positioned between the housing front portion and the housing rear portion, and the pulling module rotates.

14. The feeding device of claim 1, further comprising a sensor unit,
wherein the sensor unit includes at least one of:
a weight sensor coupled to the feeding housing and measuring a weight of the feeding housing; and
a roller sensor coupled to the roller and measuring a load applied to the roller.

15. A feeding system comprising:
a feeding device; and
a transfer device positioned behind the feeding device,
wherein the feeding device includes:
a feeding housing open upward;
a roller rotatably coupled to the feeding housing, at least a part of the roller being accommodated in the feeding housing; and
a cutter unit positioned in the feeding housing and protruding upward,
wherein the roller rotates while facing a face of the feeding housing,
wherein the transfer device includes:
a conveyor frame positioned behind the feeding housing; and
a first conveyor module and a second conveyor module which are coupled to the conveyor frame and arranged side by side.

16. The feeding system of claim 15, wherein each of the first conveyor module and the second conveyor module extends rearward from a front end of the conveyor frame, and
wherein the first conveyor module and the second conveyor module operate independently of each other.

17. The feeding system of claim 16, wherein the first conveyor module and the second conveyor module transfer a bag,
wherein the transfer device further includes an attitude sensor measuring an attitude of the bag,
wherein the attitude sensor includes at least one of:
a light sensor including a light transmitter transmitting at least one of a laser beam and infrared light and a light receiver receiving light generated by the light transmitter;
an ultrasonic sensor including an ultrasonic transmitter transmitting an ultrasonic wave and an ultrasonic receiver receiving the ultrasonic wave generated by the ultrasonic transmitter; and
a camera positioned above the bag and able to obtain an image of the bag.

18. A feeding method of cutting a bag containing a powder and feeding the powder, the feeding method comprising:
measuring a state of the bag in a state where the bag is put into a feeding housing;
determining whether the state of the bag is a final state;
when the state of the bag is the final state, determining whether the bag has been discharged from the feeding housing;
when the bag has not been discharged from the feeding housing, determining whether a period in which the final state is maintained is greater than or equal to a second period; and
when the period in which the final state is maintained is greater than or equal to the second period, reshaping the bag in the feeding housing,
wherein after reshaping the bag is completed, measuring the state of the bag is performed.

19. The feeding method of claim 18, further comprising:
when the state of the bag is not the final state, determining whether a period in which the state of the bag maintains an initial state or an intermediate state is greater than or equal to a first period,
wherein when the period in which the state of the bag maintains the initial state or the intermediate state is less than the first period, measuring the state of the bag is performed, and
wherein when the period in which the state of the bag maintains the initial state or the intermediate state is greater than or equal to the first period, reshaping the bag in the feeding housing is performed.

20. The feeding method of claim 18, wherein reshaping the bag in the feeding housing comprises:
a roller reverse rotation step of rotating, in a second rotational direction, a roller that is positioned in the feeding housing and discharges the bag from the feeding housing when the roller rotates in a first rotational direction;
a discharge auxiliary unit operation step in which a discharge auxiliary unit operates to change a position or an attitude of the bag with respect to the feeding housing; and
a roller forward rotation step in which the roller rotates in the first rotational direction.
